(19) United States
(12) Patent Application Publication
(10) Pub. No.: US 2025/0338997 A1
(43) Pub. Date: Nov. 6, 2025

(54) INSULATING AND CORROSION-RESISTANT STRUCTURE FOR COOKING APPARATUS

(71) Applicant: UBERDESIGN.COM INC., Los Angeles, CA (US)

(72) Inventor: Elliot C.R. Cook, Los Angeles, CA (US)

(21) Appl. No.: 19/208,852

(22) Filed: May 15, 2025

Related U.S. Application Data
(63) Continuation of application No. PCT/US23/80223, filed on Nov. 17, 2023.
(60) Provisional application No. 63/426,229, filed on Nov. 17, 2022.

(51) Int. Cl. A47J 37/07; A23B 4/052; A23L 5/10; A47J 36/02; F24C 15/00; F24C 15/02; F24C 15/34

(52) U.S. Cl. CPC A47J 37/0704; A23B 4/052; A23L 5/15; A47J 36/02; F24C 15/004; F24C 15/005; F24C 15/006; F24C 15/02; F24C 15/34

(57) ABSTRACT

A cooking apparatus includes a metallic shell lined with a ceramic subassembly and an aerogel insulating material interposed between the ceramic subassembly and the metallic shell, the metallic shell enclosing a cooking compartment having a door. The cooking apparatus may further include an outer metallic shell spaced apart from an exterior of the metallic shell, creating a space, and upper and lower vents allowing air to flow by convection between the metallic shell and the outer shell. The cooking apparatus may further include a substantially transparent pane of aerogel-glass composite material interposed between an interior of the first chamber and an exterior of the apparatus.

### PRIORITY CLAIM

The present application is a continuation of International Patent Appl. No. PCT/US23/80223, filed Nov. 17, 2023, which claims priority to U.S. Provisional Patent Application Ser. No. 63/426,229 filed Nov. 17, 2023, which is entirely incorporated herein by reference.

### FIELD

The subject matter described herein relates generally to an improved structure for a cooking apparatus, and associated systems, methods, and devices.

### BACKGROUND

Grilling and smoking are popular methods of food preparation that have existed for much of human history. The refinement of materials in modern times has allowed for advancement of grilling and smoking technology from fireplaces and open flames to include individual units that can grill and smoke food and may be permanently installed in one location or can be transported for use in various locations and can include enclosed chambers. As such, a wide variety of modern grills and smokers exist, from low-end, cheap versions to top-of-the-line installations costing thousands or tens of thousands of dollars.

Grills and smokers are often used in spacious outdoor settings, where it is expected that the exterior of the grill or smoker will get hot enough to burn flesh and scorch materials that are in proximity. However, high exterior temperatures present an unacceptably greater risk when a grill or smoker is used in a relatively small or vulnerable outdoor space, for example, in a marine environment or urban balcony. High exterior temperatures are also a problem when young children are present. In addition, poor insulation causes a higher consumption of fuel to maintain interior temperatures than would otherwise be possible.

It is also desirable to provide viewing windows so that food being cooked can be observed without opening the cooking chamber. However, glass windows in grills and smokers are subject to heat damage, transmit an excessive amount of heat, and are difficult to clean.

Additionally, grills and smokers may rapidly stain and corrode when used in certain exterior environments, such as in marine applications. Prior grills and smokers have nor adequately addressed this deficiency.

Thus, needs exist for improved techniques and methods for configuring grills to overcome these and other limitations of prior art grills and smokers.

### SUMMARY

Provided herein are embodiments of systems, devices and methods for configuring grills and smokers to achieve touchable exterior surfaces while maintaining high interior temperatures for grilling and smoking. A cooking apparatus as described herein may include a grill, a smoker, or a combination of a grill and smoker. The cooking apparatus is designed for outdoor use.

The cooking apparatus may include double shells with a conduit for air circulation between an inner shell defining one or more chambers for grilling or smoking and an outer shell defining an exterior of the cooking apparatus. The shells are made of a metallic material, for example, stainless steel, or mild steel with an enamel or powder coating finish. If the shells are stainless steel, they may be passivated for stain resistance and against superficial scuffing or scratching. Heat flux from the inner shell increases air temperature in the air conduit, causing the air to rise by natural convection through a vent located in an upper portion of the cooking apparatus. The rising air draws cooler air from an intake vent located in a lower portion of the cooking apparatus, which flows up and around the inner shell, reducing heat transmission from the inner shell and lowering the exterior temperature. A cover with inner and outer shells can be opened and closed for access to the cooking or smoking chamber. In another aspect, removable thermopanes provide visibility into the cooking chamber when its cover is closed.

In an alternative, or in addition, the inner shell, the outer shell, or both are layered with a high-temperature insulating material, for example, an acrogel material, on an interior or exterior of the shell. In an aspect, a substantial majority or entirety of an interior of the inner shell is fitted with a ceramic layer subassembly. The ceramic subassembly may have a glassy finish for case of cleaning. An aerogel material is interposed between the ceramic subassembly and the inner shell. The aerogel layer achieves high thermal resistance in a minimal volume, preserving the ceramic interior of the cooking apparatus for the food to be grilled or smoked. The ceramic and aerogel layers in combination with the naturally venting conduit between the outer and inner shells reduces the surface temperature of the exterior of the outer shell to ambient temperature or slightly above, eliminating the risk of burns or scorching and preserving the fuel needed for cooking.

The configuration of the apparatus described herein in detail are only example embodiments and should not be considered limiting. Other systems, apparatus, methods, features and advantages of the subject matter described herein will be or will become apparent to one with skill in the art upon examination of the following figures and detailed description. It is intended that all such additional systems, devices, methods, features and advantages be included within this description, be within the scope of the subject matter described herein and be protected by the accompanying claims. In no way should the features of the example embodiments be construed as limiting the appended claims, absent express recitation of those features in the claims.

### BRIEF DESCRIPTION OF THE FIGURES

The details of the subject matter set forth herein, both as to its structure and operation, may be apparent by study of the accompanying figures, in which like reference numerals refer to like parts. The components in the figures are not necessarily to scale, emphasis instead being placed upon illustrating the principles of the subject matter. Moreover, all illustrations are intended to convey concepts, where relative sizes, shapes and other detailed attributes may be illustrated schematically rather than literally or precisely.

FIG. 1 is an isometric view illustrating an example embodiment of a grill and smoker with a balcony mounted support rack, for mounting on a rail.

FIG. 2 is a front view further illustrating the grill and smoker shown in FIG. 1.

FIG. 3 is a side view further illustrating the grill and smoker shown in FIG. 1, particularly mounted on a rail.

FIG. 4 is a rear view further illustrating the grill and smoker shown in FIG. 1.

FIG. 5A is a simplified cross-sectional view further illustrating the grill and smoker shown in FIG. 1.

FIG. 5B is another simplified cross-sectional view further illustrating the grill and smoker shown in FIG. 1.

FIG. 6 is a second cross-sectional view further illustrating the grill and smoker shown in FIG. 1.

FIG. 7 is a diagram illustrating aspects of surface passivation using chromium oxide.

FIG. 8 is a flow diagram illustrating steps of a method for grilling food using a cooking apparatus as described herein.

### DETAILED DESCRIPTION

Before the present subject matter is described in detail, it is to be understood that this disclosure is not limited to the particular embodiments described, as such may, of course, vary. It is also to be understood that the terminology used herein is for the purpose of describing particular embodiments only, and is not intended to be limiting, since the scope of the present disclosure will be limited only by the appended claims.

Provided herein are systems, devices, and methods for improving modular grills and smokers used to cook food. The features disclosed herein may be applied to and used with the modular cooking apparatus described in U.S. patent application Ser. No. 15/284,348 filed Oct. 3, 2016 (the '348 Application), now U.S. Pat. No. 10,729,272, which application is incorporated herein by reference in its entirety. The modular cooking apparatus is micro-coated with an oxide layer and may include a heating source location; a first chamber defined by at least one first chamber wall; a second chamber defined by at least one second chamber wall and coupled with the first chamber, wherein the first chamber wall and the second chamber wall are micro-coated with the oxide-layer; an inlet vent coupled with the second chamber; and an outlet vent coupled with the second chamber, wherein, during operation of the apparatus, the first chamber is operable to cook food by retaining heat generated in the heating source location and wherein, during operation of the apparatus, the second chamber defines an airflow corridor such that air located exterior to the second chamber is drawn into the apparatus via the inlet vent and air heated in the airflow corridor is emitted from the apparatus via the outlet vent. However, features of the present disclosure may be used in other cooking apparatus and are not limited to use with the modular cooking apparatus disclosed in the '348 Application.

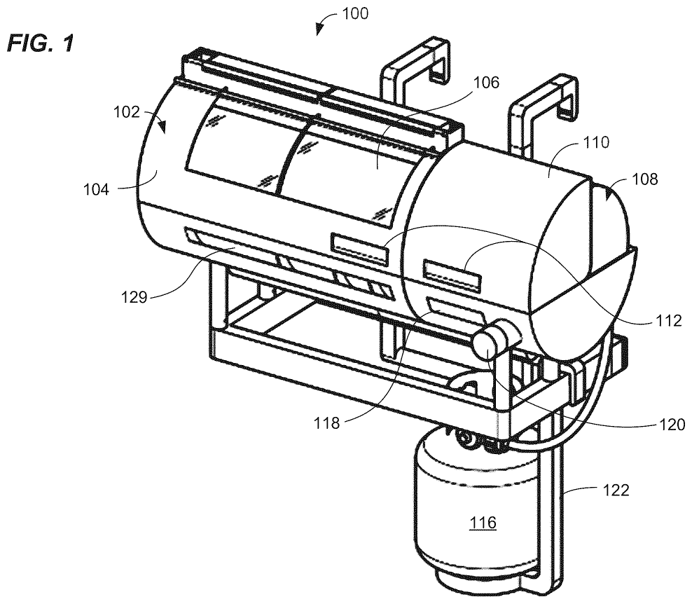

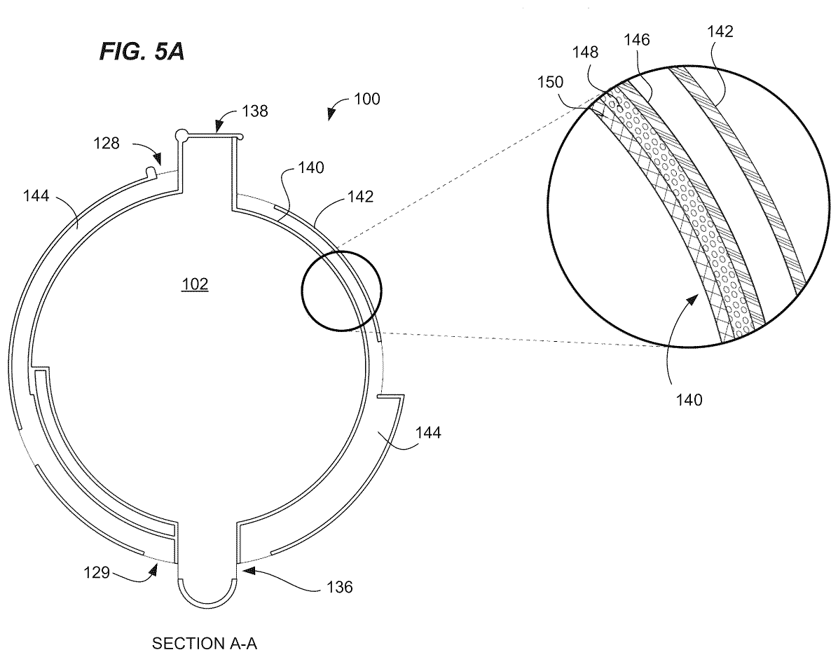

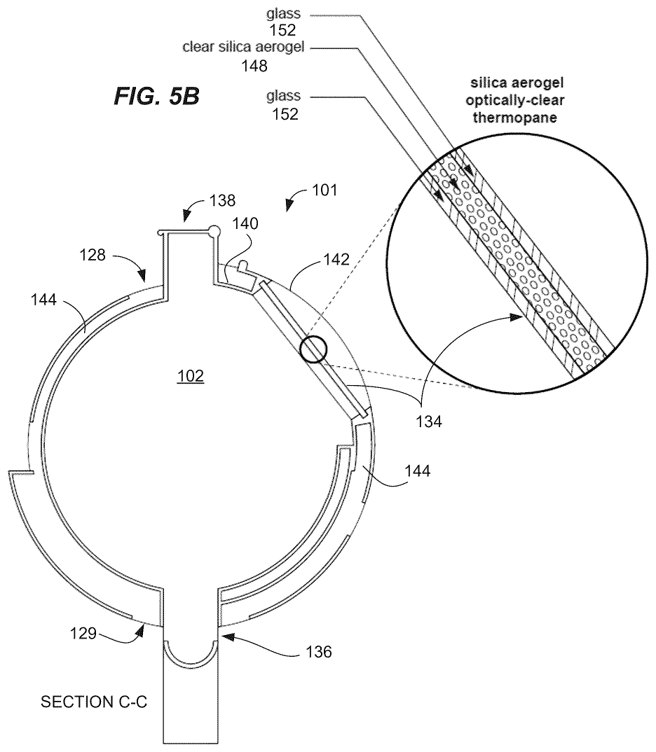

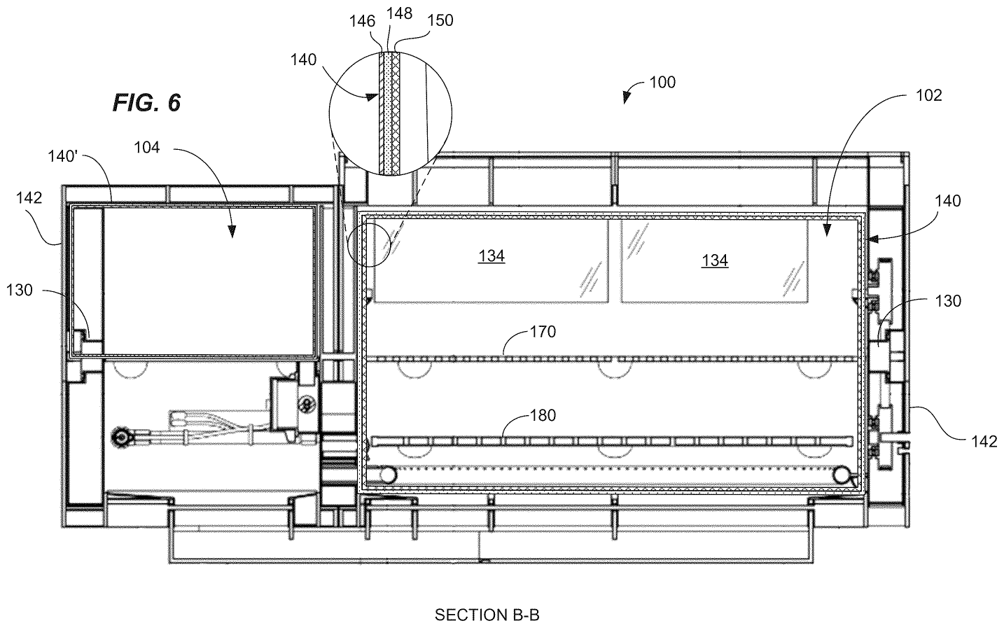

FIGS. 1-4 show exterior views of an example of the several modular grill and smoker combination apparatuses as described in the '348 Application, configured for mounting on a rail 106. The present cooking apparatus may be configured as any one of the embodiments disclosed in the '348 Application, or may be configured in any other manner that makes use of the features shown and described herein. Cross-sectional views of the cooking apparatus 100 are shown in FIGS. 5A-6.

FIGS. 1-6 show various views of a cooking apparatus 100 including improved interior and insulation features. In various embodiments, an improved cooking apparatus 100 may include a scalable primary chamber 102, having a generally cylindrical or semi-cylindrical interior and exterior profile with a primary chamber access door 104 that closes the scalable primary chamber 102. When closed, scalable primary chamber 102 can have a substantially airtight seal, providing a compartment in which food can be grilled, smoked, or otherwise cooked. This primary chamber 102 is also referred to herein as a cooking chamber.

A secondary closable chamber 108, which can be scalable in some embodiments, can also be cylindrical or semi-cylindrical, can have similar radial or other dimensions, when compared to cooking chamber 102 and can have a similar secondary chamber access door 110 that opens and closes to seal secondary chamber 108. In some embodiments, this can be an airtight seal. Secondary chamber 108 can have an equal or shorter cylindrical length, when compared to that of cooking chamber 102. Secondary chamber 108 may be configured as a utility chamber. Handles 112 can be formed as built-in recesses, exterior flanges and can have other structures and can be permanently coupled to each of chambers 102, 108 to open and close chambers 102, 108. Other structures can also be used for handles, as known in the art or later developed, including exterior horizontal, diagonal or vertical bars with or without connecting brackets.

Primary chamber 102 and secondary chamber 108 can be independently constructed or fabricated and combined or coupled later to form a cooking apparatus 100 in some embodiments. In other embodiments, these chambers can be constructed or fabricated from a single, large chamber. As would be understood in the art, additional or fewer chambers can be provided, and dimensions can be varied in accordance with the embodiments described herein without departing from their scope.

In some embodiments secondary chamber 108 can be a utility or control chamber that can be specially designed to be used for warming food, maintaining food temperature with minimal heat loss, storing items, cooking food at different temperatures from primary chamber 102 or performing other purposes.

The chambers 102, 108 can have one or more external fuel coupling components 114 for allowing externally supplied fuel to be fed to appropriate fuel sinks, such as one or more burners, in the cooking apparatus 100. Components 114 can be dedicated to each chamber 102, 108 or shared in some embodiments. A non-exhaustive list of external fuel sources 116 includes: liquid propane gas (LPG), butane, natural gas (NG), liquid or gaseous biofuels, hydrogen, kerosene and others currently in existence or later developed. In some embodiments no couplings may be provided if internal fuel is the only fuel for use, for instance in embodiments solely for use with combustible solid fuels such as charcoal, wood and others currently in existence or later developed. Many embodiments allow for the use of either or both external and internal fuel sources. Also contemplated are electrical heating sources, such as coils, that may be externally or battery powered.

In some embodiments, one or more displays can be provided on a user-facing surface of the cooking apparatus 100. These displays may include, for example, a primary display 118 that can be a Liquid Crystal Display (LCD), Light Emitting Diode (LED) display, touchscreen display, or others as appropriate and can include electrical coupling to power sources, temperature sensors, timers, lighting, audio speakers, additional displays, user interfaces, processors, non-transitory memory, and others as understood in the art. In some embodiments, these displays can be communicatively coupled to one or more external devices, such as smartphones, tablets, wearable smart devices, video game consoles, computers or other devices. These couplings can be wired or wireless and can be accomplished using various communication protocols or standards, such as Wi-Fi, Bluetooth or others. In other embodiments of the cooking apparatus 100, displays may be omitted.

User interface controls 120 can be provided or mounted on various surfaces of the cooking apparatus 100, including: dials, buttons, switches, knobs, touchscreens, combinations thereof and others. As understood in the art, these user interface controls 120 allow a user to interface with cooking apparatus 100 to control temperatures in chambers 102, 108, timers, clocks, power, lighting, fuel, audio output, and other necessary and optional components.

Other mechanical, electrical and electro-mechanical components and features can be included on appropriate interior and exterior surfaces including support racks, holders, tables, cutting boards, pots, pans, storage compartments, and others as understood in the art without departing from the scope of the embodiments described herein.

A support rack 122 supporting primary and secondary chambers 102, 108, as well as a fuel source 116, which in this case is a LPG tank. In various embodiments, support racks 122 can be highly adjustable by users, including pitch, height and balancing adjustments. In some embodiments, these support racks 122 can be installed on balconies, fences, walls, boat railings, and many others.

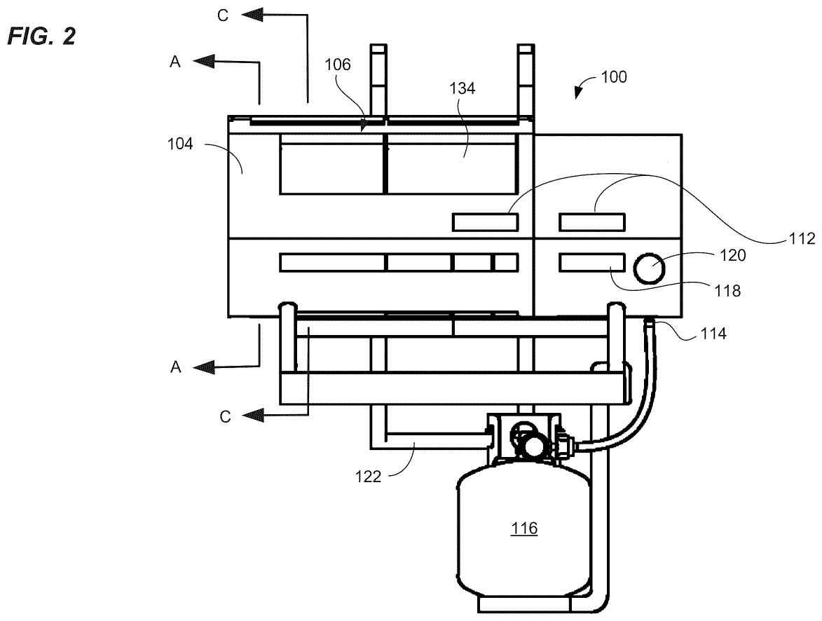

FIG. 2 is a front view of the cooking apparatus 100 showing windows 106 including transparent thermally insulating panels 134. The one or more windows 106 can include panels 134 that are double glazed, optically transparent, semi-transparent or combinations thereof, that can be removable and adjustable. The windows 106 may allow a user to visually monitor the interior of cooking chamber 102 while cooking chamber door 104 is closed. Various transparent and semi-transparent materials and combinations of materials can be used to create windows 106 including glass, high-temperatures plastics, transparent silica aerogel (e.g., Thermopane™, or AeroShield™ by AcroShield Materials, Boston, Massachusetts), and others, and may have one or a variety of colors across the visible light spectrum. A window 134 may be coupled in place using appropriate mechanisms, such that it does not fall off or otherwise move out of place while being easily removable without tools for cleaning. In embodiments, the window pane 134 may be constructed of a high-temperature material, such as a high-temperature glass or glass/aerogel composite material. The thermal insulating, removable transparent or semi-transparent panel 134 provides an improved viewing window into the interior cooking chamber 102 while being removable for, for example, washing or cleaning using suitable glass cleaning materials.

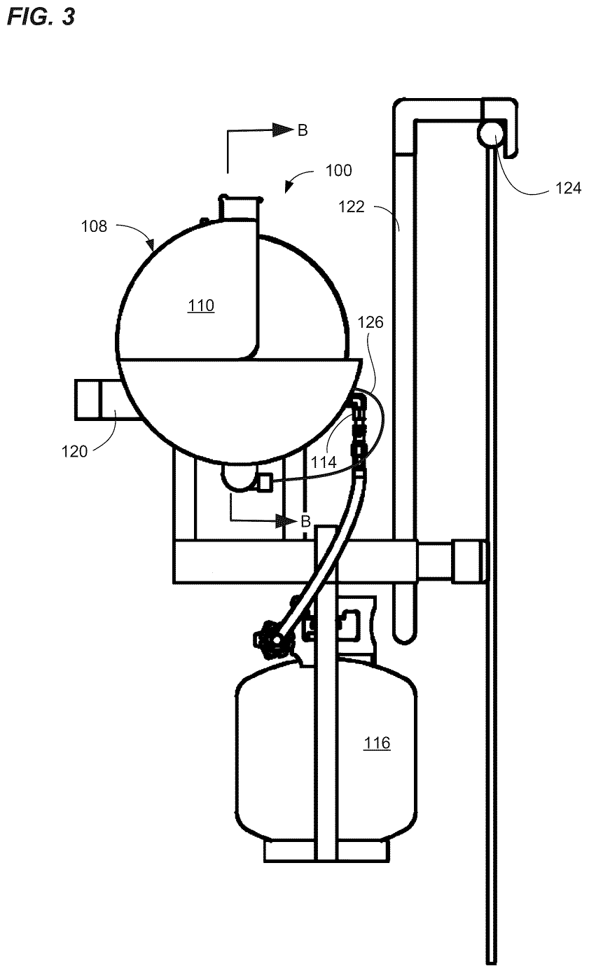

FIG. 3 is a side view depicting an example embodiment of a cooking apparatus 100 with a support rack 122 mounted on a rail 124. In the example embodiment a user interface knob 120 is shown extending out of a front surface of the cooking apparatus 100. A secondary chamber door 110 is shown as having a quarter circular side profile and is rotatably coupled with secondary chamber 108. As such, secondary chamber door 110 can rotate about a centrally located pivot 130 (FIG. 6) to open secondary chamber 108. In other embodiments, chamber doors can be three quadrants of a cylinder, a third of a cylinder, five-eighths of a cylinder or others as appropriate. Although not shown, ridges, tracks and other guiding components can be included in various embodiments to maintain door 110 in a consistent location.

An external fuel coupling component 114 is shown protruding from a rear of the cooking apparatus 100 and extending downward at a right angle to couple with a mated coupling component from an external fuel source 116. Also shown is an exterior wire 126 for providing electrical power, in the form of a rotisserie motor power line. In some embodiments this can be provided or routed within the inside the cooking apparatus device 100. A support rack 122 is shown as supporting the external fuel source 116 as well as the cooking apparatus 100 that can provide permanent, semi-permanent or removable coupling for its supported components. The support rack 122 may be used to install the cooking apparatus 100 in urban balconies or in maritime environments, for example on boat railings. The cooking apparatus may in alternative embodiments be supported using other structures, for example legs for supporting the cooking apparatus on a floor or ground surface.

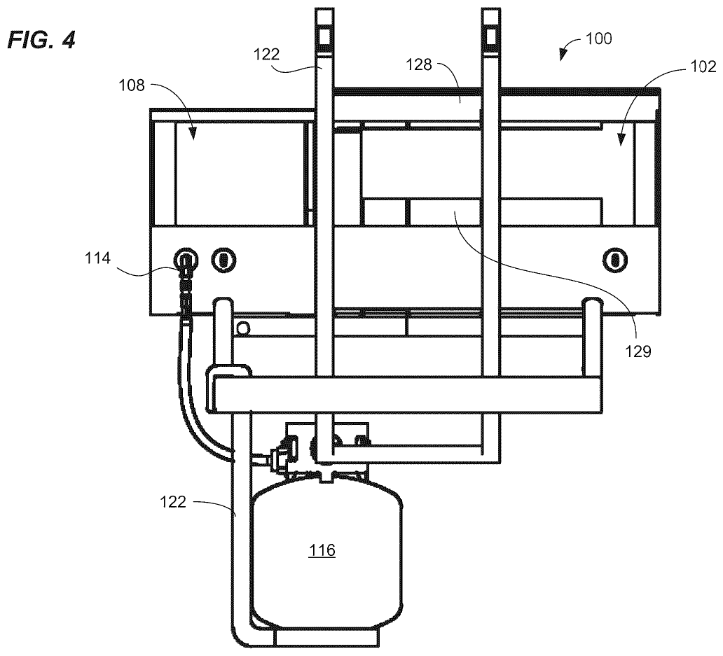

FIG. 4 is a rear view depicting an example embodiment of a cooking apparatus 100 with a support rack 122. As shown in the example embodiment, an upper air exhaust flue 128 can include one or more vents, allowing air to exit the interior of cooking apparatus 100. A rear air intake vent 129 can allow air to enter the interior of cooking apparatus 100. Venting components and systems may be as further described in the '348 Application.

FIG. 5A shows a cross-sectional view through the primary chamber 102, with an enlarged view of an inner shell 140 defining the primary chamber 102. An outer shell 142 defines an exterior of the apparatus 100 and together with the inner shell 140 define a cooling air channel 144. The cooling channel 144 admits cool air at a lower inlet 129. The admitted air is heated by heat from the primary chamber 102 and rises upward, exiting from the channel at the upper vent 128. Constant flow of air through the cooling channel 144 maintains the outer shell 142 at a substantially lower temperature than the inner shell 140. In addition, air handling features in the apparatus 100 may include a lower air inlet 136 into the primary chamber 102 to enable combustion of fuel in the chamber, and an upper outlet 138 for exhausting combustion gasses

The inner shell 140 may include a layered construction including at least three layers as shown in the enlarged view. An innermost layer 150 may be made of a ceramic material with a glassy inner surface for ease of cleaning. The ceramic subassembly 150 may have a substantially uniform thickness in the approximate range of 0.0625 inches to 0.25 inches. Suitable ceramic materials for the subassembly 150 may include, for example, high-purity ceramic alumina panels (aluminum oxide, Al2O3), high temperature ceramic coating, high alumina ceramic cement (aluminum oxide, Al2O3), woven continuous filaments of high alumina ceramic fibers (aluminum oxide, Al2O3). The inner shell 140 may further include an outer metallic layer 146 formed of passivated stainless steel or other suitable metal, having a thickness in the approximate range of 0.0625 inches to 0.125 inches. The inner shell 140 may further include an intermediate insulating layer 148 of aerogel or other suitable material, having a thickness in the approximate range of 0.0625 inches to 0.375 inches. Suitable aerogel materials may include, for example, Pyrogel XTE™ available from Aspen Aerogels. Pyrogel® XTE is a flexible, high-performance, acrogel blanket insulation designed for use in industrial applications and available in a blanket form. The combination of the three layers 146, 148, 150 create a thermal barrier that substantially lowers the temperature of the outer shell 142. The ceramic layer 150 and aerogel layer 148 may be coextensive, or substantially coextensive, with each other and with the inner layer 146.

FIG. 5B shows an alternative cross-sectional view through the primary chamber and thermally insulating pane 134, showing how the thermally insulating pane can be interposed directly between the primary chamber 102 and an exterior of the apparatus 101. When constructed of a composite of high-temperature glass 152 and a transparent or semi-transparent silica aerogel layer 148, the pane 134 may provide sufficient insulation such that the exterior of the pane 134 is safe to touch, despite being exposed directly, at its interior surface, to the primary chamber 102 being maintained at anticipated cooking temperatures. In an alternative or in addition to use of an acrogel insulating pane, dual panes of high-temperature glass separated by a cooling channel may be used to keep the outermost exterior surface of the panes at a temperature safe to touch. Details of the thermally insulating pane 134 may be as described, for example, by Dr. Elise Strobach in her thesis “High Temperature Annealing for Structural Optimization of Silica Aerogels in Solar Thermal Applications” 2020, Massachusetts Institute of Technology, which is incorporated by reference herein. The same or similar materials may be available as AeroShield™ by AeroShield Materials, Boston, Massachusetts.

FIG. 6 shows a cross-sectional view of the cooking apparatus 100 taken at a right angle to the view of FIG. 5. FIG. 6 shows the primary chamber 102 and secondary chamber 104 each surrounded by separate inner shells 140, 140′ having the three-layer construction described above. In an alternative, if the secondary chamber is not used to combust fuel, the inner layer 140′ may consist essentially of a single metallic layer 146. While the three-layer construction of the inner shell 140 is shown in combination with the nested shells 140, 142 and the cooling air channel 144, it should be understood that the three-layer construction may also be useful to enclose a primary cooking chamber 102 in a cooking apparatus having only a single shell. The cooking chamber 102 may include in its interior a metallic grill 170 for supporting food to be cooked. The grill 170 may positioned over any suitable heat source 180, for example, a gas manifold, placed in a lower portion of the cooking chamber 102.

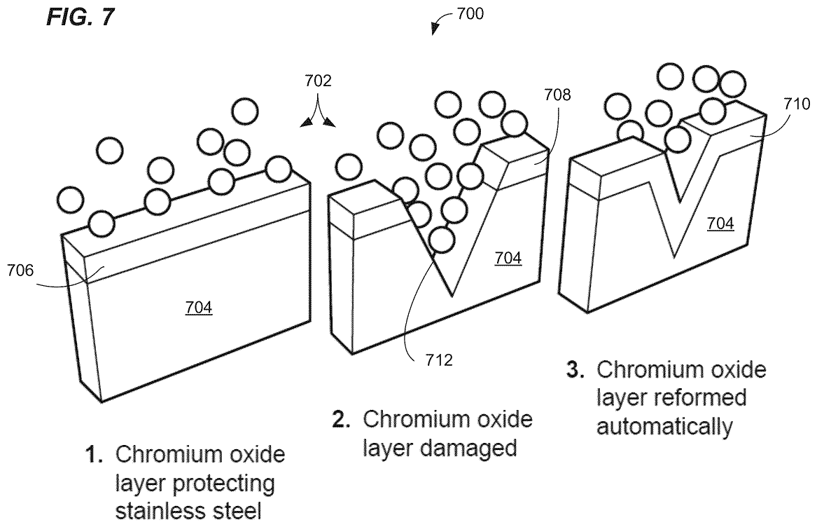

FIG. 7 shows a schematic 700 of a self-healing chromium oxide passivation layer 706 provided on a stainless steel substrate 704 for protection against oxidating molecules 702. Dimensions are merely illustrative and not to scale. At 708, the chromium oxide layer is disrupted by a scratch 712, which exposes the substrate 704 to the oxidating molecules 702. At 710, the chromium oxide layer has “healed” the scratch by flowing to cover exposed surfaces of the substrate 704. The passivated substrate 704 exemplifies a suitable material for an outer shell 142 (FIGS. 5A, 5B) covering an exterior of the cooking apparatus 100. The passivation protects the exterior of the cooking apparatus from corrosion in harsh environments such as found in marine and other applications, maintaining an attractive, easy to clean exterior. Any suitable process may be used to passivate the stainless steel outer shell 142, for example, by submersion in a passivating nitric or citric acid bath solution.

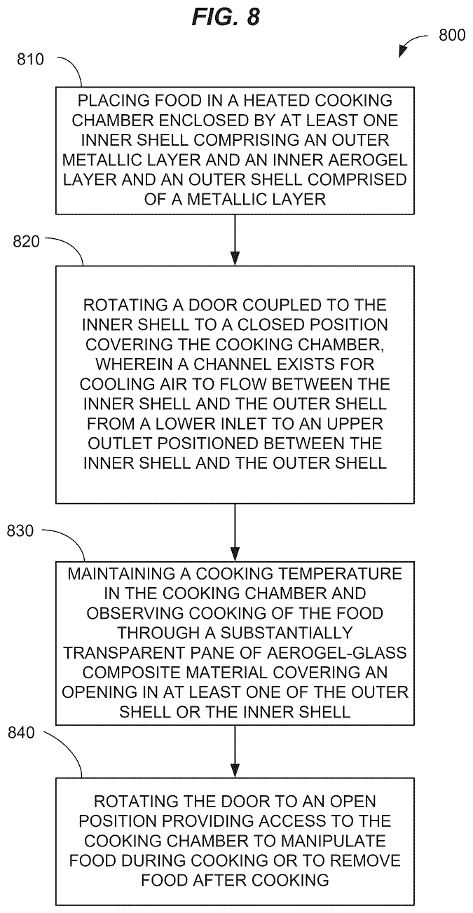

A cooking apparatus as described herein may be used in a method 800 for grilling food, as shown in FIG. 8. The method 800 may include, for example, at 810 placing food on a grill in a preheated cooking chamber. The cooking chamber may be enclosed by at least one inner shell comprising an outer metallic layer and an inner aerogel layer and an outer metallic shell spaced apart from an exterior of the inner shell. An opening in the inner and outer shells for access to the grill may be exposed by rotating a door to an open position. Heating and temperature control in the cooking chamber may be accomplished using any suitable method. The superior insulation provided by the aerogel insulation and dual shell should preserve fuel or energy needed for cooking the food and provide a more uniform internal temperature. The door may be include the inner and outer shells configured as described.

The method 800 may further include at 820 rotating the door coupled to the inner and outer shells to a closed position covering the opening in the cooking chamber. When the door is in the closed position, a channel exists for cooling air to flow between the inner shell and the outer shell, from a lower inlet to an upper outlet positioned between the inner shell and the outer shell.

The method 800 may further include, at 830, maintaining the cooking chamber at a cooking temperature and observing cooking of the food through a substantially transparent pane of acrogel-glass composite material covering an opening in the inner and outer shells. During cooking, the air channel and aerogel layer, in combination, provide a uniform temperature in the cooking chamber while maintaining an exterior of the outer shell at a temperature cool enough to touch without injury. The method 800 may further include, at 840, rotating the door to an open position providing access to the cooking chamber to manipulate food during cooking or to remove food after cooking is completed.

Various aspects have been presented in terms of systems that may include several components, modules, and the like. It is to be understood and appreciated that the various systems may include additional components, modules, etc. and/or may not include all the components, modules, etc. discussed in connection with the figures. A combination of these approaches may also be used.

As used herein and in the appended claims, the singular forms “a”, “an”, and “the” include plural referents unless the context clearly dictates otherwise.

The publications discussed herein are provided solely for their disclosure prior to the filing date of the present application. Nothing herein is to be construed as an admission that the present disclosure is not entitled to antedate such publication by virtue of prior disclosure. Further, the dates of publication provided may be different from the actual publication dates which may need to be independently confirmed.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the following description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances, entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic) intervening entities) and the indirect coupling of two entities (with one or more non-negligible intervening entities). Where entities are shown as being directly coupled together, or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

1. A cooking apparatus, comprising:
a cooking chamber surrounded by at least one inner shell; and
an outer shell coupled to the inner shell, forming a channel for cooling air to flow between the inner shell and the outer shell from a lower inlet to an upper outlet positioned between the inner shell and the outer shell,
wherein, during operation of the apparatus, the cooking chamber is operable to cook food by retaining heat generated by combustion, and
wherein the inner shell comprises a metallic layer and an aerogel layer.

2. The cooking apparatus of claim 1, wherein the inner shell further comprises a ceramic layer distal from the metallic layer and the aerogel layer is interposed between the metallic layer and the ceramic layer.

3. The cooking apparatus of claim 1, further comprising a substantially transparent pane of aerogel-glass composite material interposed between an interior of the first chamber and an exterior of the apparatus.

4. The cooking apparatus of claim 1, wherein the outer shell consists essentially of a passivated stainless-steel material.

5. The cooking apparatus of claim 4, wherein the passivated stainless steel material comprises a chromium oxide outer layer.

6. The cooking apparatus of claim 2, wherein the ceramic layer comprises a subassembly of one or more ceramic panels fastened to the inner shell.

7. The cooking apparatus of claim 6, wherein the ceramic panels have a substantially uniform thickness in a range of 0.0625 to 0.25 inches.

8. The cooking apparatus of claim 2, wherein the ceramic layer is configured with a glassy finish on an interior side facing the first chamber.

9. The cooking apparatus of claim 2, wherein the ceramic layer comprises a configuration selected from the group consisting of: a panel, a coating, a cement, and a fabric.

10. The cooking apparatus of claim 9, wherein the ceramic layer comprises alumina (Al₂O₃).

11. The cooking apparatus of claim 1, wherein the aerogel layer comprises a flexible aerogel blanket.

12. The cooking apparatus of claim 2, wherein the aerogel layer comprises a flexible aerogel blanket.

13. The cooking apparatus of claim 12, wherein the aerogel layer has a thickness in the range of 0.0625 to 0.375 inches.

14. The cooking apparatus of claim 3, wherein the substantially transparent pane of aerogel-glass composite material comprises a silica aerogel layer interposed between layers of glass.

15. The cooking apparatus of claim 14, wherein at least one of the layers of glass consists of a high-temperature glass.

16. The cooking apparatus of claim 3, wherein the substantially transparent pane of aerogel-glass composite material covers an opening in the inner and outer shells.

17. The cooking apparatus of claim 16, wherein a door comprising a portion of the inner and outer shells pivots relative to the inner and outer shells between a closed position covering the cooking chamber and an open position exposing the cooking chamber for access from an exterior of the cooking apparatus.

18. The cooking apparatus of claim 17, wherein the cooking apparatus is configured such that the door does not cover the opening in the inner and outer shells when rotated to the closed position.

19. The cooking apparatus of claim 1, further comprising a substantially transparent multi-pane glass window interposed between an interior of the cooking chamber and an exterior of the apparatus.

20. A method for grilling food using a cooking apparatus, the method comprising:
placing food in a cooking chamber enclosed by at least one inner shell comprising an outer metallic shell and an inner aerogel layer and an outer metallic shell spaced apart from the inner shell;
rotating a door coupled to the inner and outer shells to a closed position covering the cooking chamber, wherein a channel exists for cooling air to flow between the inner shell and the outer shell from a lower inlet to an upper outlet positioned between the inner shell and the outer shell;
observing cooking of the food through a substantially transparent pane of aerogel-glass composite material covering an opening in the inner and outer shells; and
rotating the door to an open position providing access to the cooking chamber to manipulate food during cooking or to remove food after cooking.
